(19) United States
(12) Patent Application Publication
(10) Pub. No.: US 2026/0267756 A1
(43) Pub. Date: Sep. 10, 2026

(54) NEGATIVE CONSTRAINED PATH-BASED TESTING METHOD

(71) Applicant: CESKÉ VYSOKÉ UCENÍ TECHNICKÉ V PRAZE, 160 00 Praha 6 (CZ)

(72) Inventors: Miroslav BURES, Zizkov (CZ); Matej KLIMA, 147 00 Praha 4, (CZ)

(73) Assignee: CESKÉ VYSOKÉ UCENÍ TECHNICKÉ V PRAZE, 160 00 Praha 6 (CZ)

(21) Appl. No.: 18/869,487

(22) PCT Filed: Jun. 23, 2023
(86) PCT No.: PCT/CZ2023/000031

§ 371 Date: Nov. 26, 2024

(51) Int. Cl. G06F 11/28

(52) U.S. Cl. CPC G06F 11/28

(57) ABSTRACT

A method of Negative Constrained Path-based Testing (NCPT) for automatic and efficient performing software and hardware tests and obtaining cost-optimal test scenarios from SUT model, denoted G, G=(N,E), wherein N represents a set of nodes N, and E represents a set of edges. The method employs processes and workflows of a System Under Test (SUT) which are modelled using a structure based on a directed graph and an algorithm generates cost-optimal test scenarios from the SUT model. The core principle of NCPT, differently to existing path-based testing techniques, is to restrict particular parts of the SUT workflow to be tested, when the test scenario explored certain, preceding, parts of the workflow.

### TECHNICAL FIELD

The method of Negative Constrained Path-based Testing (further also as “NCPT”) according to this invention serves to automatically create test scenarios for software and electronics systems. Processes and workflows of a System Under Test (SUT) are modelled using a structure based on a directed graph and an algorithm generates cost-optimal test scenarios from the SUT model.

### BACKGROUND ART

The goal of path-based testing is to create suitable test cases, sequences of actions or functions in a SUT and execute them. Path-based testing is usually understood as one field of Model-based Testing (MBT), which automates the process. The principle of MBT is to model particular aspect of SUT by a suitable formal notation and generate the test cases automatically from the model. In case of path-based testing, we model processes, workflows, or state machines of the SUT. As formal model, structures based on directed graphs are usually used. Test cases are a set of paths in the model, hence path-based testing. Test cases must satisfy given test coverage criteria, sets of rules determining their strength by specifying which combinations of system functions in the model must be sequenced in the paths.

The core principle of NCPT, differently to existing path-based testing techniques, is to restrict particular parts of the SUT workflow to be tested, when the test scenario explored certain, preceding, parts of the workflow.

In contrast to previous path-based testing techniques, the proposed NCPT can execute several important situations in system testing that do not have direct support by existing techniques. The following situations can be given:
Management of testing costs—certain situations can be too costly for the given tests and have to be excluded from test scenarios.
Feasibility of certain tests—when a test reaches certain parts of the system workflow, internal state of the SUT might change and it disables continuation of the test in other certain part of the workflow. Such a situation in the industry is usually resolved “ad hoc when it happens”, in the test design, or in the test execution. However, such approach is sub-optimal from cost viewpoint. NCPT prevents such situations.
Outages of particular parts of test environment—in more complex projects, parts of the processes might be temporarily unavailable due to hardware or software limitations. This fact has to be reflected in the tests.
Time consuming asynchronous operation—when an action A represents a start of an asynchronous operation and action B represents its end, the rest of the system can be tested in the meantime. In this case, such test case that would call again the operation between actions A and B must not be present in the exercised set of the test scenarios.
A need of using only a reduced subset of resources—There might be processes in a SUT that use some resources extensively and when the availability of such resources is limited, they need not to be executed. For example, an energy intensive process might not be executed on a system with low battery level.

To handle these situations, we are introducing defined negative constraints into the SUT model. This is a novel approach in path-based testing. Two types of negative constraints can be defined in the SUT model:
An action A must NOT be followed by an action B in a test case in a test set (several test steps might be present between actions A and B, so concept of test requirements is not directly applicable here)
An action A can be followed by an action B in a test case in a test set (several test steps might be present between actions A and B, so concept of test requirements is not directly applicable here) ONLY ONCE.

Compared to the way when a test engineer creates these tests in a manual way, benefits of the methods are:
Cost optimality of tests (test scenarios are minimized while maintaining given criteria of their strength)
Defined strength of test scenarios is guaranteed via test coverage criterion
Reduction of duplications in the test cases
Significantly faster preparation of the test cases

### Summary of Related Work to Which NCPT Differs

In path-based testing, the typical notation of this problem's model is based on a directed graph, whose nodes model actions, functions, or decision points in the SUT and edges model transitions between these actions (Beizer, 2003; Ammann and Offutt, 2016; Bures and Ahmed, 2019).

A test case is generally defined as a path from a start node of the model to any of its end nodes. The set of all test cases must satisfy a defined test coverage criterion. From the most common criteria, the edge, the edge-pair, and the prime path coverage can be mentioned (Ammann and Offutt, 2016).

A number of algorithms generating test cases for various coverage criteria were published (Shirole and Kumar, 2013; Arora et al. 2017; Bures and Ahmed, 2019; Li et al. 2012; Bures et al. 2019; Anand et al. 2017). However, none of the known algorithms or approaches do not support negative constraints in the generation of test scenarios.

In path-based testing, the key established concept in is a set of test requirements. Test requirements are paths in SUT model that must all be present as subpaths in the test cases (Shirole and Kumar, 2013; Ammann and Offutt, 2016). If not explicitly designed to satisfy a particular test coverage criterion, algorithms creating test cases usually accept test requirements as one of their inputs (Li et al. 2012). Test requirements can be used to ensure that the test cases will satisfy given test coverage criteria or for prioritization of certain parts of SUT model to be tested with higher intensity.

However, current test case generation strategies using the concept of test requirements completely fail to reflect negative constraints, which is making NCPT entirely original.

Previous attempts to reflect the constraints in test case generation have been done in data-flow testing (DFT) discipline, focused on program code-level testing. DFT field overlaps with general path-based testing. Its main principle is to verify the SUT variables by inspecting their definition and use, which is done by extracting the so-called def-use pairs from the code. Each pair is exercised with respect to the selected test coverage criteria (Su et al. 2017).

However, the strategies and algorithms generating the test paths are proprietarily designed to test the programs and are difficult to be combined with test coverage criteria suitable for general path-based testing. Moreover, only a positive constraint (action A must be followed by an action B) is handled by these techniques. This makes NCPT completely original compared to any of previous DFT proposals.

### REFERENCES CITED IN THE DESCRIPTION

Non-patent literature cited in the description:
Ammann, P., & Offutt, J. (2016). Introduction to software testing. Cambridge University Press.
Anand, S., Burke, E. K., Chen, T. Y., Clark, J., Cohen, M. B., Grieskamp, W., . . . & Zhu, H. (2013). An orchestrated survey of methodologies for automated software test case generation. Journal of Systems and Software, 86 (8), 1978-2001.
Arora, V., Bhatia, R., & Singh, M. (2017). Synthesizing test scenarios in UML activity diagram using a bio-inspired approach. Computer Languages, Systems & Structures, 50, 1-19.
Beizer, B. (2003). Software testing techniques. Dreamtech Press.
Bures, M., & Ahmed, B. S. (2019). Employment of multiple algorithms for optimal path-based test selection strategy. Information and Software Technology, 114, 21-36.
Bures, M., Ahmed, B. S., & Zamli, K. Z. (2019). Prioritized process test: An alternative to current process testing strategies. International Journal of Software Engineering and Knowledge Engineering, 29 (07), 997-1028.
Li, N., Li, F., & Offutt, J. (2012, April). Better algorithms to minimize the cost of test paths. In 2012 IEEE Fifth International Conference on Software Testing, Verification and Validation (pp. 280-289). IEEE.
Shirole, M., & Kumar, R. (2013). UML behavioral model based test case generation: a survey. ACM SIGSOFT Software Engineering Notes, 38 (4), 1-13 .
Su, T., Wu, K., Miao, W., Pu, G., He, J., Chen, Y., & Su, Z. (2017). A survey on data-flow testing. ACM Computing Surveys (CSUR), 50 (1), 1-35.

### SUMMARY OF THE INVENTION

The method involves several basic steps to be carried out to automatically create test scenarios for software and electronics systems, which will be discussed below.

Furthermore, this invention also shows implementation of the algorithms involved in the steps of present method. However, the essence of the present invention lies generally in the combination of the further described steps, resulting in that the invention is not limited by the specific algorithms used. The person skilled in the art will readily understand that alternative algorithms resulting in receiving similar results may be employed.

To generate the test scenarios from a SUT model, process or workflow in a SUT is abstracted via directed graphs, where a directed graph, denoted G, is composed from nodes, denoted N, and directed edges, denoted E. Nodes model actions or decision points in the workflow, whereas an edge is a transition between two nodes. Model contains a start node, denoted nₛ and can contain a set of end nodes, denoted Nₑ.

Cycles in graph are allowed. Meaning that there can exist a path in the graph that starts in node n and ends in the same node n.

Parallel edges are not allowed. Meaning that there cannot exist multiple edges with the same source node n and target node m, where n≠m

Test scenario is a path from start node nₛ to any of the end nodes Nₑ of the model.

Algorithm generates a set of test scenarios that satisfy given test coverage criterion.

Negative constraints are defined as TYPE-NODE 1-NODE 2

More constraints of one type can be defined in a SUT model; both types of constraints can be present in the model.

The constraints are input to the algorithm as members of set of negative constraints, denoted NC.

TYPE EXCLUSIVE means that NODE 1 must not be followed anywhere in the test scenario by NODE 2 in any of the test scenario in the set of test scenarios.

TYPE ONLY ONCE means that NODE 1 can be followed anywhere in the test scenario by NODE 2 only once in only one of the test scenarios in the set of test scenarios.

The test coverage criterion is that each edge of the SUT model must be visited minimally once by at least one of the test scenarios, however if this condition conflicts with defined negative constraints, the negative constraint has a higher priority and as a consequence some edges may not be present in the test scenarios.

Thus, the method being the subject of this invention employs the further described essential steps to be carried out. First, it shall be defined that the method employs use of following parameters:
wherein TP represents an intermediate set of test paths comprised of sequences of edges,
wherein T represents a final set of test paths comprised of sequences of edges,
wherein V represents a set of visited edges,
wherein e represents a transition between nodes (activities) inside a SUT model,
wherein path P_start represents a sequence of edges,
wherein path P_end represents a sequence of edges,
wherein path P represents a sequence of edges,
wherein Boolean variable x can equal either true, or false value,
wherein path p_nodes represents a sequence of nodes of path p, where p_nodes is made in a way that each node in p_nodes is both a source (start of the transition) of each edge in the original path p and the target (end of the transition) of the last edge in p,
wherein nc represents a negative constraint from a set of negative constraints NC. Regarding the types of negative constraints, type EXCLUSIVE-n1-n2 means that a node n1 must not be followed by node n2 in any of the paths in the set of test paths, and type ONLY ONCE-m1-m2 means that a node m1 can be followed by node m2 only once in only one of the test paths in the set of test paths.

The method comprises following basic steps:
B) A) creating temporary variables used in the method: empty sets TP representing an intermediate set of test paths and V representing a set of visited edges;
C) B) traversing all edges, where each edge represents a transition between activities inside a modeled process (in FIG. 1 edges 1 to 22; in FIG. 2 edges 201 to 244; in FIG. 4 edges 301 to 348).
D) C) for each edge denoted e that is not yet added to V, firstly finding a path corresponding to an adjacent sequence of edges denoted P_start from the start node (SA in FIG. 1, SA2 in FIG. 2, and SA3 in FIG. 3) to e and then secondly finding a path denoted P_end that goes from the edge e to any end node;
E) D) joining the paths from steps C) to create a resulting path P (an example of such path 1,2,4,5,6,9 is emphasized by a bold line in FIG. 1) that is added to set TP and adding each edge in TP to V, wherein the set TP is made of the individual paths.
F) E) applying on set TP the filtering sub-algorithm, wherein first a new set denoted T is created and all paths from TP are copied into T.
G) F) using the sub-algorithm to traverse each negative constraint pair denoted nc (in Example 1 such nc is TYPE EXCLUSIVE-U2-W2, in Example 2 such nc is TYPE ONLY ONCE-I3-L3);
H) G) using the sub-algorithm to create a variable x, which is set to false and for each nc traversing paths in TP
I) H) if traversed path denoted p_nodes from TP (viewed as a sequence of nodes) contains nc, then decide according to the type of nc and the state of variable x, whether the path represented by a sequence p_nodes shall be removed from T or whether x shall be set to true;
J) I) obtaining the resulting set of test paths in T

Advantageously, in step H), if nc is of type EXCLUSIVE (there is such nc in Example 1, specifically TYPE EXCLUSIVE-U2-W2) or if x is equal to true, then path represented by a sequence p_nodes is removed from T.

Advantageously, in step H), if nc is of type ONLY ONCE (there is such nc in Example 2, specifically TYPE ONLY ONCE-I3-L3), then x is set to true.

The method can be demonstrated on the following example. An example problem model comprised from nodes N={SA1, A1, B1, C1, D1, E1, F1, G1, H1, I1, J1, K1, L1, EA1, EB1, EC1}, and edges E={1, 2, . . . , 21, 22}, where a start node nₛ is SA1, and end nodes Ne are EA1, EB1, and EC1. The example model is depicted in FIG. 1.

We demonstrate a test case SA1,A1,B1,C1,D1,E1,EA1 in FIG. 1, emphasized by a bold line.

The method works as follows: First, we create empty sets TP and V. Then, we traverse all edges in the model (in FIG. 1 edges 1 to 22; in FIG. 2 edges 201 to 244; in FIG. 4 edges 301 to 348). For each edge denoted e that is not yet added to V, we firstly find a path (an adjacent sequence of edges) denoted P_start from the start node to e. Secondly, we find a path denoted P_end that goes from the edge e to some end node. Then we join such paths to create a resulting path P (an example of such path 1,2,4,5,6,9 is emphasized by a bold line in FIG. 1), which is added to set TP and each edge in TP is added to V. Such set TP for the model illustrated above is made of the following set of paths (for sake of simplicity, individual paths in the list are sequences of nodes)
1. SA1,A1,B1,C1,D1,E1,EA1
2. SA1,A1,B1,A1,B1,C1,D1,E1,EA1
3. SA1,A1,B1,C1,D1,F1,C1,D1,E1,EA1
4. SA1,A1,B1,C1,D1,E1,C1,D1,E1,EA1
5. SA1,A1,B1,C1,D1,E1,G1,I1,K1,EB1
6. SA1,A1,B1,C1,D1,F1,G1,I1,K1,EB1
7. SA1,A1,B1,C1,D1,F1,H1,J1,L1,EC1
8. SA1,A1,B1,C1,D1,E1,G1,H1,J1,L1,EC1
9. SA1,A1,B1,C1,D1,F1,H1,J1,I1,K1,EB1
10. SA1,A1,B1,C1,D1,E1,G1,I1,K1,I1,K1,EB1

Then, we apply on set TP the filtering sub-algorithm. At first, it creates a new set denoted T, and stores there all paths from TP. Then, it traverses each negative constraint pair, denoted nc, from a set of negative constraint pairs, denoted NC, creates a variable x, which is set to false and for each nc it traverses paths in TP. If traversed path (denoted p_nodes) from TP (in this place it is viewed as a sequence of nodes) contains nc, two possible situations may happen according to the type of nc and the state of variable x:
1. If nc is of type EXCLUSIVE, or if x is equal to true, path represented by a sequence p_nodes is removed from T.
2. If nc is of type ONLY ONCE, x is set to true.
   In the end of the filtering sub-algorithm, T contains the resulting set of test paths.

Examples of the resulting test paths in T are as follows. If the input set of negative constraints NC is equal to a negative constraint EXCLUSIVE-E1-K1, T contains the following sub-paths:
1. SA1,A1,B1,C1,D1,E1,EA1
2. SA1,A1,B1,A1,B1,C1,D1,E1,EA1
3. SA1,A1,B1,C1,D1,F1,C1,D1,E1,EA1
4. SA1,A1,B1,C1,D1,E1,C1,D1,E1,EA1
5. SA1,A1,B1,C1,D1,F1,G1,I1,K1,EB1
6. SA1,A1,B1,C1,D1,F1,H1,J1,L1,EC1
7. SA1,A1,B1,C1,D1,E1,G1,H1,J1,L1,EC1
8. SA1,A1,B1,C1,D1,F1,H1,J1,I1,K1,EB1

If the set of input negative constraints NC is equal to a negative constraint ONLY ONCE-E1-K1, T contains the following sub-paths:
1. SA1,A1,B1,C1,D1,E1,EA1
2. SA1,A1,B1,A1,B1,C1,D1,E1,EA1
3. SA1,A1,B1,C1,D1,F1,C1,D1,E1,EA1
4. SA1,A1,B1,C1,D1,E1,C1,D1,E1,EA1
5. SA1,A1,B1,C1,D1,E1,G1,I1,K1,EB1
6. SA1,A1,B1,C1,D1,F1,G1,I1,K1,EB1
7. SA1,A1,B1,C1,D1,F1,H1,J1,L1,EC1
8. SA1,A1,B1,C1,D1,E1,G1,H1,J1,L1,EC1
9. SA1,A1,B1,C1,D1,F1,H1,J1,I1,K1,EB1

### BRIEF DESCRIPTION OF THE DRAWINGS

FIG. 1 shows basic example model employing steps of the present invention.

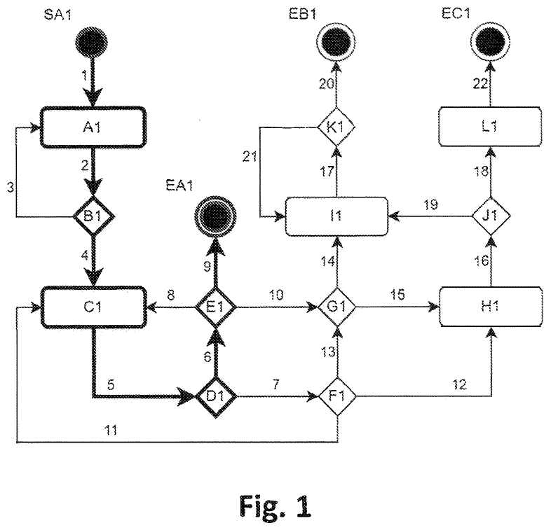

FIG. 2 shows scheme of model situation of system of smart emergency vehicles routing system testing using steps of the present invention to create a corresponding test scenario;

FIG. 3 shows scheme of model situation of rescue mission management system supporting combat lifesaving (CLS) operation, wherein the testing using steps of the present invention to create a corresponding test scenario is employed;

### DETAILED DESCRIPTION OF THE INVENTION

The present invention is further described by the following examples of implementation of the method steps according to this invention, which should not be construed as limiting the scope of the invention.

### Particular Algorithm Generating the Test Scenarios

### Algorithm 1: Create Test Cases

Input: Set of negative constraints NC, SUT model G=(N,E)
Output: Collection of test cases T

### Algorithm Steps:

1 Create an empty set TP
2 Create an empty set V
3 For each edge (denoted e) in the set of edges E, follow steps 4-7:
4 If edge e is not in the set V, follow steps 5-7:
5 Set P to equal the output of sub-algorithm 2: Find Path(e, G); e and G are inputs to this sub-algorithm
6 For each edge (denoted p) in P, add edge p to the set V
7 Add path P to the set TP
8 Create a new set T that is equal to the output of sub-algorithm 5: Filter_Test_Paths(TP, NC, G); TP, NC, and G are inputs to this sub-algorithm
9 Return the set T

### Sub-algorithm 2: Find Path

Input: Edge e, SUT model G
Output: New test path P

### Algorithm Steps:

1 Create empty sets V_start, P_temp, P_start
2 Set P_start to equal the output of sub-algorithm 3: Find_Path_From_Start(e, V_start, P_temp, P_start, G); e, V_start, P_temp, P_start, and G are inputs to this sub-algorithm
3 Create empty sets V_end, P_temp, P_end
4 Set P_end to equal the output of sub-algorithm 4: Find_Path_To_End(e, V_end, P_temp, P_end, G); e, V_end, P_temp, P_end, and G are inputs to this sub-algorithm
5 Create an empty queue (denoted P)
6 For each edge (denoted p_start) in the set P_start, append p_start to queue P
7 For each edge (denoted p_end) in the set P_end, append p_end to queue P
8 Return queue P

### Sub-algorithm 3: Find Path From Start

Input: Edge e, set of visited edges V_start, queue of edges beginning in the start node, and the resulted path stored in queue P_start, SUT model G

### Algorithm Steps:

1 If the source node of edge e has no incoming edges, follow steps 2-4:
2 If the queue P_start is empty or if the size of the queue P_start is larger than the size of the queue P_temp, follow steps 3-4:
3 Clear all elements of queue P_start
4 Add all elements from the queue P_temp to the queue P_start
5 For each edge (denoted e_parent) in the set of edges incoming the source node of edge e, follow steps 6-8:
6 Create a new queue P′_temp with the same content as is in the queue P_temp
7 Add edge e_parent to P′_temp
8 If edge e_parent is not element of the set V_start, call sub-algorithm 3: Find_Path_From_Start(e_parent, V_start, P′_temp, P_start, G); e_parent, V_start, P′_temp, P_start, and G are inputs to this sub-algorithm

### Sub-algorithm 4: Find Path To End

Input: Edge e, set of visited edges V_end, queue of edges from the start to edge P_temp, and the resulted path P_end, SUT model G

### Algorithm Steps:

1 Add edge e to the set V_end
2 Create a new queue P′_temp with the same content as in the queue P_temp
3 Add edge e to the queue P′_temp
4 If the target node of edge e has no outgoing edges, follow steps 5-7:
5 If the queue P_end is empty or if the size of the queue P_end is larger than the size of the queue P_temp, follow steps 6-7:
6 Clear all elements in the queue P_end
7 Add all elements from the queue P_temp to the queue P_end
8 For each edge (denoted e_child) in the set of edges outgoing the target node of edge e, follow step 9:
9 If edge e_child is not element of the set V_end, call sub-algorithm 4: Find_Path_To_End(e_child, V_end, P′_temp, P_end, G); e_child, V_end, P′_temp, P_end, and G are inputs to this sub-algorithm

### Sub-algorithm 5: Filter Test Paths

Input: Set of test paths TP, set of negative constraints NC, and SUT model G
Output: Collection of test cases T

### Algorithm Steps:

1 Create a new set T with the same content as in the set TP
2 For each pair (denote nc) in the set NC, follow steps 3-10:
3 Set x to equal ‘false’
4 For each queue of edges (denoted p_edges) in the set TP, follow steps 5-11:
5 Create queue p_nodes and make it to equal the source and end nodes of all edges in the queue p_edges
6 Set x to equal the index of node nc_predecessor in queue p, or −1 if it is not member of queue p
7 If i is larger than −1, follow steps 7-11:
8 Set j to equal the index of node nc_successor in queue p or −1 if it is not member of queue p:
9 If i is smaller than j, follow steps 10-11:
10 If x is equal to ‘true’, or nc_type is EXCLUSIVE, remove queue p from the set T
11 Else set x to equal ‘true’
12 Return the set T

### EXAMPLES OF APPLICATION CASES

### Example 1

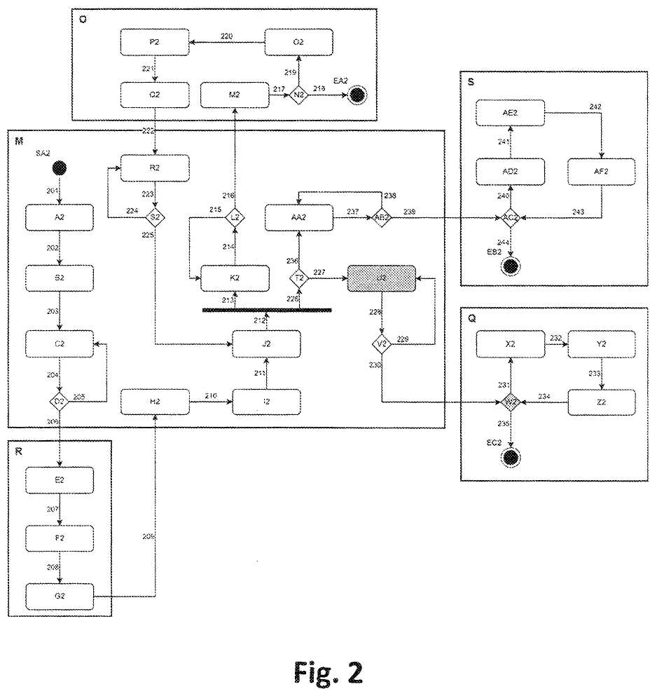

We describe a system of smart emergency vehicles routing system, that composes of a stabile back-end part denoted M and few subsystems R, O, S, and Q. The example is further schematically described in FIG. 2.

Subsystem denoted R represents a traffic intensity sensor, subsystem denoted O represents a smart emergency vehicle, subsystem denoted S represents a smart traffic sign, and subsystem denoted Q represents a smart semaphore. When an emergency situation arrives at M, it, based on the traffic intensity from subsystem R, plans a route for O. Based on that route, M is also able to control the traffic using S and Q. During an emergency scenario with the highest priority, both subsystems S and Q are employed. During an emergency scenario with a normal priority, only S is employed. Therefore, we must model the process with both possibilities, although in a normal priority emergency, only S is used.

If the test scenarios are prepared not reflecting the fact that subsystem Q might be used, test engineer has to cope with this situation ad-hoc, which is strongly suboptimal for the following reasons:
First, it takes additional time and costs to re-organize the testing process
Second, the unavailable test scenarios cannot be executed and as a consequence, much larger extent of the system is not tested, compared to the situation, when the test scenarios are systematically prepared bearing in mind that subsystem Q might not be used.

We model the situation, where subsystem Q is not included in the process as negative constraints-TYPE EXCLUSIVE-U2-W2.

Test scenarios for the situation, where subsystem Q is not included in the emergency scenario (negative constraints are not activated and the requirement for test coverage is that each edge of the SUT model must be visited minimally once by at least one of the test scenarios) will be:
1. SA2,A2,B2,C2,D2,E2,F2,G2,H2,I2,J2,K2,L2,M2,N2,EA2
2. SA2,A2,B2,C2,D2,C2,D2,E2,F2,G2,H2,I2,J2,K2,L2,M2,N2,EA2
3. SA2,A2,B2,C2,D2,E2,F2,G2,H2,I2,J2,T2,U2,V2,W2,X2,Y2,Z2,W2,EC2
4. SA2,A2,B2,C2,D2,E2,F2,G2,H2,I2,J2,K2,L2,K2,L2,M2,N2,EA2
5. SA2,A2,B2,C2,D2,E2,F2,G2,H2,I2,J2,K2,L2,M2,N2,O2,P2,Q2,R2,S2,J2,K2,L2,M2,N2,EA2
6. SA2,A2,B2,C2,D2,E2,F2,G2,H2,I2,J2,K2,L2,M2,N2,O2,P2,Q2,R2,S2,R2,S2,J2,K2,L2,M2,N2,EA2
7. SA2,A2,B2,C2,D2,E2,F2,G2,H2,I2,J2,T2,AA2,AB2,AC2,AD2,AE2,AF2,AC2,EB2
8. SA2,A2,B2,C2,D2,E2,F2,G2,H2,I2,J2,T2,U2,V2,U2,V2,W2,X2,Y2,Z2,W2,EC2
9. SA2,A2,B2,C2,D2,E2,F2,G2,H2,I2,J2,T2,AA2,AB2,AA2,AB2,AC2,AD2,AE2,AF2,AC2,EB2

Now consider the situation, when the subsystem Q is not included in the emergency scenario. In this situation, previous set of test scenarios will render highly ineffective, as part of these scenarios cannot be executed in the SUT-resulting in potential defects in the SUT remaining undetected.

In contrast, test scenarios for the situation when the subsystem Q is NOT included in the emergency scenario created by NCPT according to this invention are:
1. SA2,A2,B2,C2,D2,E2,F2,G2,H2,I2,J2,K2,L2,M2,N2,EA2
2. SA2,A2,B2,C2,D2,C2,D2,E2,F2,G2,H2,I2,J2,K2,L2,M2,N2,EA2
3. SA2,A2,B2,C2,D2,E2,F2,G2,H2,I2,J2,K2,L2,K2,L2,M2,N2,EA2
4. SA2,A2,B2,C2,D2,E2,F2,G2,H2,I2,J2,K2,L2,M2,N2,O2,P2,Q2,R2,S2,J2,K2,L2,M2,N2,EA2
5. SA2,A2,B2,C2,D2,E2,F2,G2,H2,I2,J2,K2,L2,M2,N2,O2,P2,Q2,R2,S2,R2,S2,J2,K2,L2,M2,N2,EA2
6. SA2,A2,B2,C2,D2,E2,F2,G2,H2,I2,J2,T2,AA2,AB2,AC2,AD2,AE2,AF2,AC2,EB2
7. SA2,A2,B2,C2,D2,E2,F2,G2,H2,I2,J2,T2,AA2,AB2,AA2,AB2,AC2,AD2,AE2,AF2,AC2,EB2
   All of these test scenarios can be executed in the SUT minimizing the risk that some of defects will remain undetected as a result of the situation that part of the test scenarios cannot be executed in the SUT.

### Example 2

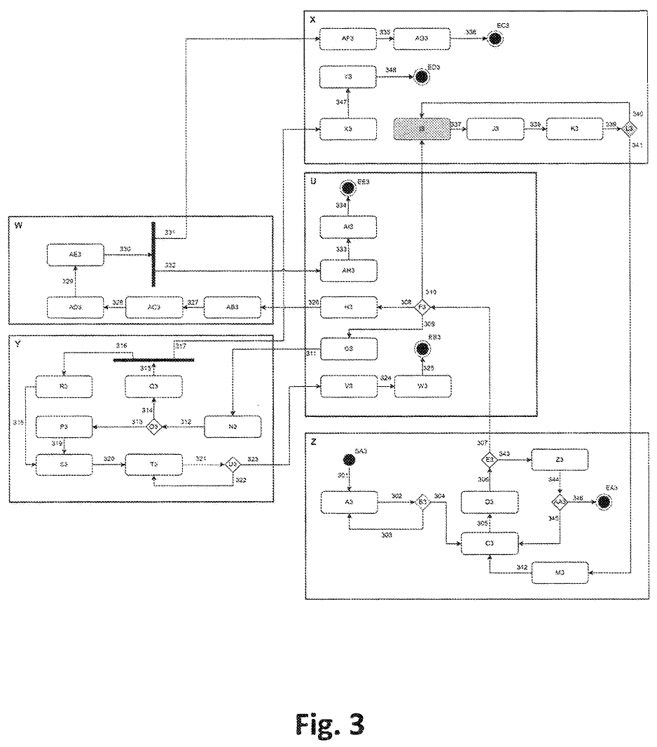

Rescue mission management system supports combat lifesaving (CLS) operation. The system is composed of several subsystems. A remote unit, denoted U, a soldier position data sensor, denoted Y, vital signs measurement unit, denoted W, and emergency signalization unit, denoted X. A remote unit communicates with a central hub that is denoted Z. The example is further schematically described in FIG. 3.

One of these subsystems, an emergency signalization unit X, can transmit a high energy intensive emergency signal that has a long-range communication potential. In the end-to-end test, the battery has enough power to activate the emergency communication unit X only once. Hence, this situation must be reflected in the test scenarios, otherwise, the scenarios will not be realistic to test—and when not executing a part of the test scenarios, defects in the system might remain undetected.

We model the situation with a use of a highly intensive energy signal as negative constraints—TYPE ONLY ONCE-I3-L3.

Theoretical test situations do not consider the fact that the component X can be activated only once (the requirement for test coverage is that each edge of the SUT model must be visited minimally once by at least one of the test scenarios) are:
1. SA3,A3,B3,C3,D3,E3,Z3,AA3,EA3
2. SA3,A3,B3,A3,B3,C3,D3,E3,Z3,AA3,EA3
3. SA3,A3,B3,C3,D3,E3,F3,G3,N3,O3,Q3,X3,Y3,ED3
4. SA3,A3,B3,C3,D3,E3,F3,H3,AB3,AC3,AD3,AE3,AH3,AI3,EE3
5. SA3,A3,B3,C3,D3,E3,F3,I3,J3,K3,L3,M3,C3,D3,E3,Z3,AA3,EA3
6. SA3,A3,B3,C3,D3,E3,F3,I3,J3,K3,L3,I3,J3,K3,L3,M3,C3,D3,E3,Z3,AA3,EA3
7. SA3,A3,B3,C3,D3,E3,F3,G3,N3,O3,P3,S3,T3,U3,V3,W3,EB3
8. SA3,A3,B3,C3,D3,E3,F3,G3,N3,O3,Q3,R3,S3,T3,U3,V3,W3,EB3
9. SA3,A3,B3,C3,D3,E3,F3,G3,N3,O3,Q3,R3,S3,T3,U3,T3,U3,V3,W3,EB3
10. SA3,A3,B3,C3,D3,E3,Z3,AA3,C3,D3,E3,Z3,AA3,EA3
11. SA3,A3,B3,C3,D3,E3,F3,H3,AB3,AC3,AD3,AE3,AF3,AG3,EC3

And here we can see that test scenario No. 6:

SA3,A3,B3,C3,D3,E3,F3,I3,J3,K3,L3,I3,J3,K3,L3,M3,C3,D3,E3,Z3,AA3,EA3 cannot be executed, and this situation is not covered in the rest of the scenarios, so there is a possibility that some defects might remain undetected.

In contrast to this ad-hoc approach, test scenarios created by NCPT correctly considering the situation when the component X can be activated only once are:
1. SA3,A3,B3,C3,D3,E3,Z3,AA3,EA3
2. SA3,A3,B3,A3,B3,C3,D3,E3,Z3,AA3,EA3
3. SA3,A3,B3,C3,D3,E3,F3,G3,N3,O3,Q3,X3,Y3,ED3
4. SA3,A3,B3,C3,D3,E3,F3,H3,AB3,AC3,AD3,AE3,AH3,AI3,EE3
5. SA3,A3,B3,C3,D3,E3,F3,I3,J3,K3,L3,M3,C3,D3,E3,Z3,AA3,EA3
6. SA3,A3,B3,C3,D3,E3,F3,G3,N3,O3,P3,S3,T3,U3,V3,W3,EB3
7. SA3,A3,B3,C3,D3,E3,F3,G3,N3,O3,Q3,R3,S3,T3,U3,V3,W3,EB3
8. SA3,A3,B3,C3,D3,E3,F3,G3,N3,O3,Q3,R3,S3,T3,U3,T3,U3,V3,W3,EB3
9. SA3,A3,B3,C3,D3,E3,Z3,AA3,C3,D3,E3,Z3,AA3,EA3
10. SA3,A3,B3,C3,D3,E3,F3,H3,AB3,AC3,AD3,AE3,AF3,AG3,EC3
   All these test scenarios can be executed in the SUT and there is no situation that some defects might remain undetected because certain test scenarios are not feasible in the SUT.

### INDUSTRIAL UTILIZATION

The disclosed method is particularly suitable for automatic and efficient performing software and hardware tests with optimized time consumption and reduced computing power to obtain relevant and valid test results while maintaining given criteria of the test scenario strength.

### LIST OF REFERENCE MARKS

SA1—start of the process
EA1—end of the process
EB1—end of the process
EC1—end of the process
A1—an action in the process
B1—an action in the process
C1—an action in the process
D1—an action in the process
E1—an action in the process
F1—an action in the process
G1—an action in the process
H1—an action in the process
I1—an action in the process
J1—an action in the process
K1—an action in the process
L1—an action in the process
1—a transition to another action in the process
2—a transition to another action in the process
3—a transition to the previous action A if decision B equals false
4—a transition to action C in the processes if decision B equals true
5—a transition to another action in the process
6—a transition to action E if decision D equals true
7—a transition to action F if decision D equals false
8—a transition to action C if decision E equals false
9—a transition to action EA if decision E is neither true nor false
10—a transition to action G if decision E equals true
11—a transition to action C if decision F equals false
12—a transition to action H if decision F equals true
13—a transition to action G if decision F is neither true nor false
14—a transition to action I if decision G equals true
15—a transition to action H if decision G equals false
16—a transition to action C if decision F equals false
17—a transition to another action in the process
18—a transition to action L if decision J equals true
19—a transition to action I if decision J equals false
20—a transition to action EB if decision K equals true
21—a transition to action I if decision K equals false
22—a transition to another action in the process
M—backend system
R—traffic intensity sensor
O—emergency vehicle
S—smart traffic sign
Q—smart semaphore
SA2—start of the process
EA2—end of the process
EB2—end of the process
EC2—end of the process
A2—emergency initiated
B2—initiate route traffic data gathering
C2—connect to remote sensor
E2—process input information
F2—load required data from sensors
G2—send response
H2—receive route traffic data
I2—assign priority of the emergency
J2—plan emergency vehicle route
K2—connect to an emergency vehicle
M2—receive route from backend
O2—proceed in planned route
P2—update current position
Q2—send position to the backend
R2—get emergency vehicle location update
U2—connect to semaphore
X2—process semaphore setup instructions
Y2—setup semaphore
Z2—wait for semaphore update request
AA2—connect to smart traffic sign
AD2—process traffic sign's setup instructions
AE2—setup traffic sign
AF2—wait for traffic sign update request
201—a transition to another action in the process
202—a transition to another action in the process
203—a transition to another action in the process
204—a transition to another action in the process
205—connection to remote sensor unsuccessful
206—connection to remote sensor successful
207—a transition to another action in the process
208—a transition to another action in the process
209—a transition to another action in the process
210—a transition to another action in the process
211—a transition to another action in the process
212—a transition to another action in the process
213—a transition to another action in the process
214—a transition to another action in the process
215—connection to emergency vehicle unsuccessful
216—connection to emergency vehicle successful
217—a transition to another action in the process
218—route accomplished
219—continue in route
220—a transition to another action in the process
221—a transition to another action in the process
222—a transition to another action in the process
223—a transition to another action in the process
224—emergency vehicle location updates unsuccessfully
225—emergency vehicle location updates successfully
226—a transition to another action in the process
227—include semaphore information update in the emergency
228—a transition to another action in the process
229—a transition to another action in the process
230—a transition to another action in the process
231—show semaphore information
232—a transition to another action in the process
233—a transition to another action in the process
234—a transition to another action in the process
235—hide semaphore information
236—include traffic sign information update in the emergency
237—a transition to another action in the process
238—a transition to another action in the process
239—a transition to another action in the process
240—show traffic sign information
241—a transition to another action in the process
232—a transition to another action in the process
243—a transition to another action in the process
244—hide traffic sign information
Z—central hub
U—remote unit
Y—position data sensor
W—vital signs measurement unit
X—emergency signalization unit
SA3—start of the process
EA3—end of the process
EB3—end of the process
EC3—end of the process
ED3—end of the process
EE3—end of the process
A3—startup and configuration
C3—connect to a remote unit
D3—connection from central hub initiated
G3—position measurement request
H3—vital signs measurements initiation
I3—initiate emergency signalization
J3—read stored data
K3—perform emergency signalization
M3—emergency call received
N3—read position request
P3—load from cache
Q3—read location from sensor
R3—store to cache
S3—gather location information
T3—connect to a remote unit
V3—receive location information to remote unit
W3—store location data to remote unit
X3—receive location data to emergency signalization unit
Y3—store location data to emergency signalization unit
Z3—failed connecting to a remote unit
AB3—accept vital signs request
AC3—measure blood pressure
AD3—measure hearth rate
AE3—measure body temperature
AF3—receive vital signs data to emergency signalization unit
AG3—store vital signs data to emergency signalization unit
AH3—receive vital signs data to remote unit
AI3—store vital signs data to remote unit
301—a transition to another action in the process
302—a transition to another action in the process
303—startup failed
304—startup successful
305—a transition to another action in the process
306—a transition to another action in the process
307—successful connection from central hub to remote unit
308—read life functions
309—read position data
310—emergency signalization initiated
311—a transition to another action in the process
312—a transition to another action in the process
313—data cached
314—cached data unavailable
315—a transition to another action in the process
316—a transition to another action in the process
317—a transition to another action in the process
318—a transition to another action in the process
319—a transition to another action in the process
320—a transition to another action in the process
321—a transition to another action in the process
322—connection to remote unit failed
323—connection to central unit failed
324—a transition to another action in the process
325—a transition to another action in the process
326—a transition to another action in the process
327—a transition to another action in the process
328—a transition to another action in the process
329—a transition to another action in the process
330—a transition to another action in the process
331—a transition to another action in the process
332—a transition to another action in the process
333—a transition to another action in the process
334—a transition to another action in the process
335—a transition to another action in the process
336—a transition to another action in the process
337—a transition to another action in the process
338—a transition to another action in the process
339—a transition to another action in the process
340—signalization without response
341—signalization successful
342—a transition to another action in the process
343—failed connecting to remote unit
344—a transition to another action in the process
345—repeat connection to central unit
346—end process
347—a transition to another action in the process
348—a transition to another action in the process

1. A method of Negative Constrained Path-based Testing for automatic and efficient performing software and hardware tests and obtaining cost-optimal test scenarios from SUT model, denoted G, G={N, E), wherein N represents a set of nodes N, and E represents a set of edges, characterized in that the method employs use of following parameters:
wherein TP represents an intermediate set of test paths comprised of sequences of edges,
wherein T represents a final set of test paths comprised of sequences of edges,
wherein V represents a set of visited edges,
wherein e represents a transition between nodes inside a SUT model,
wherein path P_start represents a sequence of edges,
wherein path P_end represents a sequence of edges,
wherein path P represents a sequence of edges,
wherein Boolean variable x can equal either true, or false value,
wherein path p_nodes represents a sequence of nodes of path p, where p_nodes is made in a way that each node in p_nodes is both a source of each edge in the original path p and the target of the last edge in p,
wherein nc represents a negative constraint from a set of negative constraints NC and
wherein negative constraint of type EXCLUSIVE-n1-n2 corresponds to that a node n1 must not be followed by node n2 in any of the paths in the set of test paths, and
wherein negative constraint of type ONLY ONCE-m1-m2 corresponds to that a node m1 can be followed by node m2 only once in only one of the test paths in the set of test paths,
and the method further comprises following steps:
A) creating temporary variables used in the method: empty sets TP representing an intermediate set of test paths and V representing a set of visited edges;
B) traversing all edges, where each edge represents a transition between activities inside a modeled process;
C) for each edge denoted e that is not yet added to V, firstly finding a path corresponding to an adjacent sequence of edges denoted P_start from the start node to e and then secondly finding a path denoted P_end that goes from the edge e to any end node;
D) joining the paths from steps C) to create a resulting path P that is added to set TP and adding each edge in TP to V, wherein the set TP is made of the individual paths;
E) applying on set TP the filtering sub-algorithm, wherein first a new set denoted T is created and all paths from TP are copied into T;
F) using the sub-algorithm to traversing each negative constraint pair denoted nc;
G) using the sub-algorithm to creating a variable x, which is set to false and for each nc traversing paths in TP;
H) during the traversal of TP, when the traversed path denoted p_nodes from TP viewed as a sequence of nodes contains nc, then:
when nc is of type EXCLUSIVE or variable x equals true, then arranging that path represented by a sequence p_nodes is removed from T, and the traversal of TP continues, otherwise arranging that variable x is set to true, and the traversal of TP continues;
I) obtaining the resulting set of test paths in T.
